(19) United States
(12) Patent Application Publication
(10) Pub. No.: US 2022/0382828 A1
(43) Pub. Date: Dec. 1, 2022

(54) METHOD FOR APPLYING A TRANSFORMATION TO A DATA FIELD AND CORRESPONDING TRANSFORMATION DEVICE

(71) Applicant: Schölly Fiberoptic GmbH, Denzlingen (DE)

(72) Inventor: Sébastian WEITBRUCH, Niedereschach (DE)

(73) Assignee: Schölly Fiberoptic GmbH, Denzlingen (DE)

(21) Appl. No.: 17/824,185

(22) Filed: May 25, 2022

(30) Foreign Application Priority Data
May 28, 2021 (DE) 102021113909.0

(51) Int. Cl. G06F 17/14

(52) U.S. Cl. CPC G06F 17/14

(57) ABSTRACT

A method and a device for applying a transformation to a data field are provided, wherein data points are transformed using at least one transformation rule, characterized in that the data field is divided into segments, that for each data point to be transformed of the data field a test is performed to identify the segment in which the data point is arranged, and that a transformation rule is subsequently selected depending on the segment found and the rule is applied to said data point.

### INCORPORATION BY REFERENCE

The following documents are incorporated herein by reference as if fully set forth: German Patent Application No. 10 2021 113 909.0, filed May 28, 2021.

### TECHNICAL FIELD

The invention relates to a method for transforming a data field. Such transformations are widely used in practice, for example in image post-processing with regard to color values or related geometric corrections.

The invention further relates to a transformation device, having means for applying a transformation to a data field, wherein data points can be transformed with at least one transformation rule.

### SUMMARY

The object of the invention is to apply the transformation to a data field in such a way that the calculation speed is increased and the memory requirement during the calculation is reduced.

To achieve this object, the invention provides one or more of the features as described herein. In particular, it is proposed according to the invention that the data field is divided into segments, that for each data point to be transformed of the data field a test is performed to identify the segment in which the data point is arranged, and that a transformation rule is subsequently selected depending on the segment found and the rule is applied to this data point. The advantage obtained is that a location-dependent transformation rule can be stored without the need for a closed formula to be available and without the need to define an individual transformation rule—for example in the form of a lookup table—for each data point. This saves memory space and can simplify the calculation algorithm.

It is particularly advantageous if the transformation rules are given by at least one function, in particular a polynomial. For example, a polynomial of n-th degree can be defined by (n+1) coefficients. This can be used to minimize the memory requirements for the calculation. This allows for a resource-saving storage of different transformation rules.

The classical approach used in the prior art involves the use of lookup tables (LUT). For example, in a 2D problem, values are stored in LUTs for each coordinate point (x,y), wherein they characterize the values of f(x,y). A 2D lookup table can easily be implemented in software applications as a 2D array (e.g.: ARRAY[x][y]), but in hardware implementations, for example in a field programmable gate array (FPGA) or an application-specific integrated circuit (ASIC), it is very resource-intensive. In particular, FPGAs have little chip memory space.

To solve this problem in hardware applications, in the prior art smaller 2D LUTs are usually used (e.g.: ARRAY[x/100][y/100]) and missing intermediate points are interpolated. However, such an approach is still resource-intensive.

The invention, by contrast, allows LUTs to be replaced, in particular by the present method.

In a further advantageous design, it may be provided that the boundaries of the segments are described by at least one function, in particular polynomials, preferably with equipotential surfaces of the at least one function, in particular wherein the respective segment belonging to a data point is determined by finding the equipotential surfaces between which the data point is located. This means that it is easy to test numerically between which segment boundaries, and thus in which segment, a data point lies.

In this context, an equipotential surface can be understood, for example, as a set of all points in which a function assumes a constant value. Equipotential surfaces in this sense can also be a line or a higher-dimensional object.

In a further advantageous embodiment, it may be provided that the transformation rule of a segment includes at least one transformation of a boundary, for example the already mentioned boundary, of the segment. This means that interpolation points can be defined for the transformation rule.

In a further advantageous embodiment it can be provided that if the data point to be transformed is located between the boundaries of the segments, an interpolation is applied between segment boundary values of the boundaries of the segments. This enables a location-dependent, fine-grained adaptation of the transformation rule.

The data field is preferably at least two-dimensional, in particular two-dimensional, or three-dimensional. This means that typical problems found in image processing, such as correction of geometric or color-related imaging errors or brightness corrections, can be addressed.

In an alternative, the transformation can change the dimension of the data fields. Thus, the method according to the invention can be integrated into image processing methods.

In another alternative, the transformation cannot change the dimension of the data fields. Thus, the method according to the invention can be used, for example, to obtain image-related or metadata for an image.

In an advantageous embodiment, it may be provided that the transformation affects the dimensions of the data field that define the segmentation. A transformation rule can therefore be used that depends on the data points which it affects. Examples may include corrections of visual imaging errors, such as aberration or distortion.

In one advantageous embodiment, it may be provided that the transformation affects those dimensions of the data field that do not define the segmentation. This means that a transformation rule can be used that does not depend on the data points which it affects. Examples can include location-based color corrections or location-dependent brightness corrections.

In a further advantageous embodiment, it may be provided that the interpolation is linear, bilinear, trilinear, bicubic, polynomial or performed according to the nearest neighbor method. This makes it possible to select the interpolation depending on the situation and precision.

In a further advantageous embodiment, it can be provided that the interpolation comprises a subdivision of the segment into interpolation points and that as the transformation value for a data point in the segment, a value is selected which corresponds to the transformation value of the nearest interpolation point. This has the advantage that the calculation speed of the interpolation is increased. The number of interpolation points can depend on the desired precision of the interpolation. For example, a large number of interpolation points will be necessary if the desired precision is high. This provides flexibility depending on the application and situation.

The described transformation method is preferably used for geometric transformations, color transformations, and/or for generating additional parameters, in particular of hemoglobin or hematocrit concentrations or oxygen saturations. This means that the transformation method can be used in numerous applications.

A method described thus can be used for direct and indirect transformations.

For example, direct transformation can be used in this context as a term for transformations where for each data point (x,y) a new point (x′,y′) is directly determined, where y′=f(x,y) and x′=x.

Indirect transformation can be used in this context, for example, as a term for transformations where for each data point (x,y) one or more parameters Alpha(x,y) are obtained, which can then be used for the transformation on the data point (x,y) in order to obtain a new data point (x′,y′).

In order to achieve the above-mentioned object, in the case of a transformation device, according to the invention the features of the stand-alone claim directed to a transformation device are provided. In particular, in order to achieve the stated object, it is proposed according to the invention that in a transformation device of the type mentioned that the data field is divided into segments, that means are implemented for testing, for each data point of the data field to be transformed, the segment in which the data point is arranged, and that means are implemented for selecting a transformation rule depending on the segment found and that the means for transforming the data field access the selected transformation rule for the transformation of the data point.

In an advantageous design, it can be provided that means are implemented for carrying out a method according to the invention, in particular as described above and/or according to any one of the claims directed to a method. Thus, the advantages already mentioned are realized.

### BRIEF DESCRIPTION OF THE DRAWINGS

The invention will now be explained in more detail by reference to a small number of exemplary embodiments, without being limited to these few exemplary embodiments. Further variants of the invention and exemplary embodiments result from the combination of the features of individual or multiple protective claims with one another and/or with individual or multiple features of the exemplary embodiments and/or the previously described variants of devices and methods according to the invention.

In the drawings:

FIG. 1 shows a direct geometric transformation (vertical transformation),

FIG. 2 shows an indirect geometric transformation (radially symmetric transformation),

FIG. 3 shows a further indirect geometric transformation (information extraction), and

FIG. 4 shows a transformation device.

### DETAILED DESCRIPTION

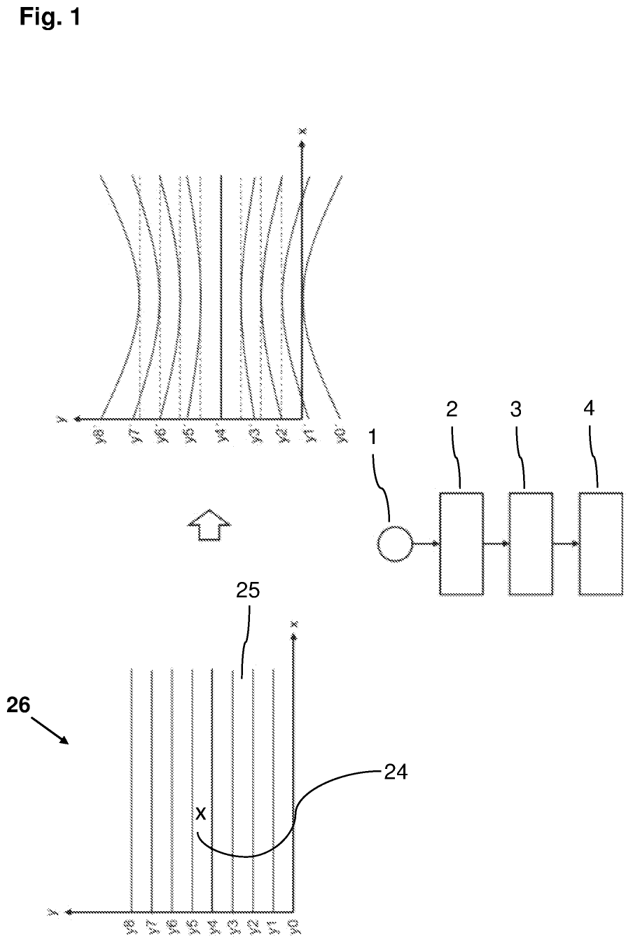

FIG. 1 shows the example of a direct geometric transformation, in this case a non-linear vertical transformation. Assume the task to be to transform the data point (x,y)(24) in such a way that a new data point (x′, y′) is obtained, where y′=f(x,y) and x′=x.

A simple solution to this problem, which is not according to the invention, would be to store a DeltaY value for each coordinate point (x,y), which represents, for example, the vertical displacement to the new value y′. An image at 1080p resolution (1920×1080 pixels) would require more than 2 million values to be stored. An image at 4K-UHD resolution would require even more storage. Therefore, usually only a portion of these values is stored and the rest interpolated, which is nevertheless very memory intensive in relation to the hardware resources, for example on an FPGA chip.

In the present solution approach, shown in FIG. 1, n vertical values yₙ (in this example: 0≤n≤8) are selected and their transformation is defined as a polynomial function.

In this example, the transformation is represented as a polynomial function in this way:

y₀′=P₀(x)

y₁′=P₁(x)

y₂′=P₂(x)
etc.
where the polynomials can be of the same or different order and can have different polynomial coefficients.

Interpolation is used to transform data points that lie between the polynomial boundaries yₙ. For example, the interpolation can be linear, bicubic, or more complex.

In this case, for each data point (x,y), where yₙ₋₁<y<yₙ, an interpolation of a new value y′ takes place between Pₙ(x) and Pₙ₋₁(x).

The individual steps, as given in FIG. 1, are as follows:

In step 1, the data field (26) and the data point (x,y)(24) to be transformed are loaded. n data values yₙ are then selected, which divide the data field into (n−1) segments (25). In step 2, the index k is determined, where yₖ<y<yₖ₊₁. In step 3, the limits of the polynomials are calculated, where yₘᵢₙ=Pₖ(x) and yₘₐₓ=Pₖ₊₁(x). In step 4, the new value y′ is transformed using an interpolation and y′ is obtained as a function of yₘᵢₙ, yₘₐₓ, y, yₖ, and yₖ₊₁.

The method shown in FIG. 1 can be used in devices such as cameras, photographic devices or television sets, FPGAs or the like. Numerous other devices are conceivable and possible.

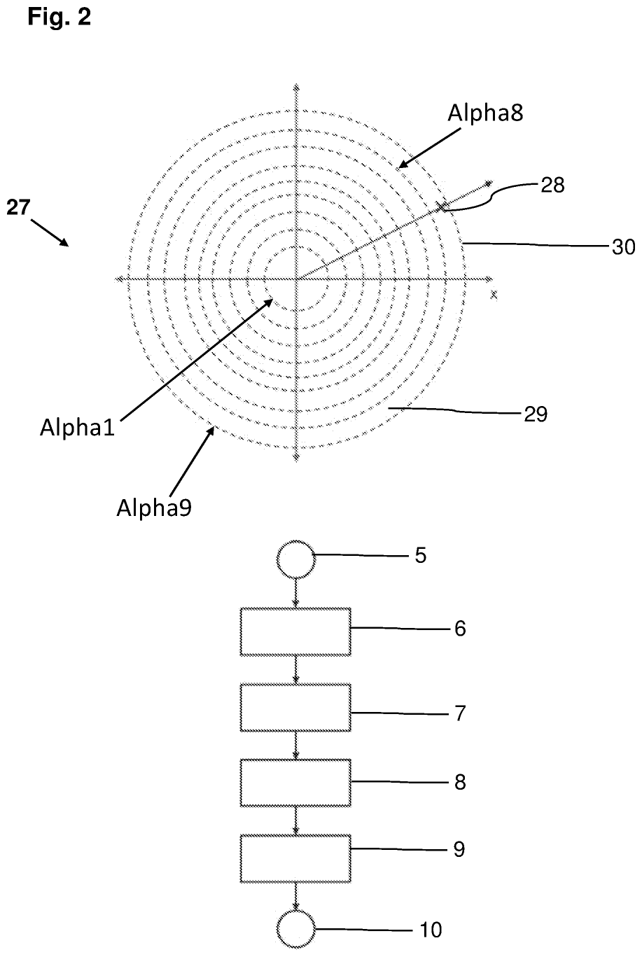

FIG. 2 shows an indirect geometric transformation, in this case a radially symmetric transformation. Assume the task is to transform the data point (x,y)(28) in such a way that different light effects, such as in a cone of light, or color shades at a different distance from the center of the axis, can be compensated. Such transformations may refer to the brightness, the color, or the like.

A first approach to this problem would be to define three values alphaR, alphaG and alphaB for each point to be transformed (e.g.: RGB pixel), which can act on this point as a multiplication factor, offset or the like, and to store them discretely. This generally requires a large amount of memory in the chip.

A solution according to the invention would be to divide the data field (27) into circular segments (29). Each circle with a different radius defines a transformation rule which is given by Alpha, preferably represented as a polynomial. Data points to be transformed, which lie between these circles with different Alpha, can be interpolated. A value Alpha(x,y) can now be assigned to each data point (x,y) (28). For the sake of simplification, Alpha(x,y) is used here, but this can also be substituted by AlphaR(x,y), AlphaG(x,y) and AlphaB(x,y).

The individual steps, as given in FIG. 2, are as follows: in step 5, the data field (27) and the data point (x,y) (28) to be transformed are loaded. The data field is divided into n circles with n different radii. In step 6, the radius R of the data point (x,y) (28) is determined, where

R=(x\hat{ }2+y\hat{ }2)\hat{ }(½) or R\hat{ }2=x\hat{ }2+y\hat{ }2.

In step 7, the index k is determined, where Rₖ<R<Rₖ₊₁. This means that the position of the data point (x,y) (28) and the corresponding boundaries (30) of the segment (29) are determined. In step 8 the values Alphaₘᵢₙ and Alphaₘₐₓ are determined, where Alphaₘᵢₙ=Pₖ(f(x,y)) and Alphaₘₐₓ=Pₖ₊₁ (f(x,y)) and where P is a polynomial and f(x,y) denotes an image parameter/characteristic at position x,y, for example Hue, Saturation, Brightness, or individual color values such as red, green, and blue. In step 9 a new value for Alpha is interpolated, where Alpha(x,y) is a function of Alphaₘᵢₙ, Alphaₘₐₓ, R, Rₖ and Rₖ₊₁. In step 10, the value Alpha(x,y) is output.

In further exemplary embodiments, Alphaₘᵢₙ, Alphaₘₐₓ and Alpha(x,y) can have multiple components. For example, Alphaₘᵢₙ can have the components AlphaRₘᵢₙ=P_{R,k}(Red(x,y)), AlphaGₘᵢₙ=P_{G,k}(Green(x,y)), AlphaBₘᵢₙ=P_{B,k}(Blue(x,y)), where Red, Green and Blue are the intensities in the respective color channels red, green and blue. The same applies to Alphaₘₐₓ and Alpha(x,y).

In the example shown graphically in FIG. 2, there are 10 circles and thus 10 values for Alpha, namely Alpha₀, Alpha₁, . . . , Alpha₉. Depending on the application and degree of difficulty, the data field (27) can of course be divided into more or fewer circle segments.

The example shown graphically in FIG. 2 is deliberately simplified. In other embodiments, other non-circular geometric forms, such as elliptical, oval or the like, are possible.

The method illustrated in FIG. 2 can be implemented in devices such as microscopes, endoscopes, night vision devices, light sources or the like. Numerous other devices are conceivable and possible.

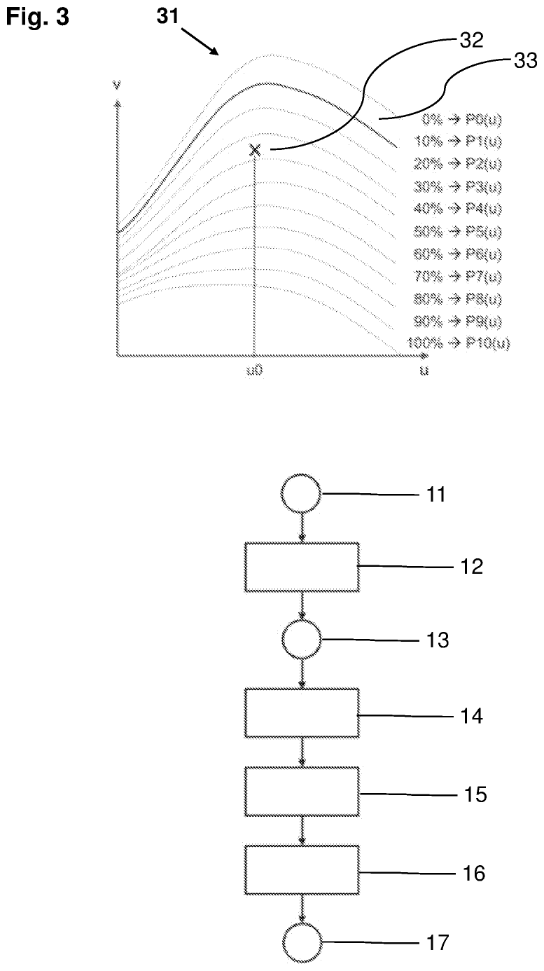

FIG. 3 shows an indirect geometric transformation, in this case an information extraction. Assume the task to be to extract information from a data field (31) and an associated data point (x,y) (32). This may be color information or more complex information such as a hemoglobin value, hematocrit value, oxygen saturation, or the like.

The individual steps, as given in FIG. 3, are as follows: In step 11, the data field (31) and the data point (x,y) (32) to be transformed are loaded. In step 12, the coordinates (u,v) are determined, i.e. a color transformation takes place. In step 13, the data point (u₀,v₀) (32) is obtained. The data field (31) is divided into (n−1) segments (33) using n polynomials P. In step 14, the index k is determined, where Pₖ(u₀)<v₀<Pₖ₊₁(u₀), i.e. the point (u₀,v₀) is located within the segment bounded by Pₖ and Pₖ₊₁. In step 15, the segment boundary values, which are given by the polynomial values Pₖ(u₀) and Pₖ₊₁(u₀), are determined. One possibility would be to use a lookup table (LUT) for Alpha, which has n entries, where Alphaₘᵢₙ=AlphaLUT(k) and Alphaₘₐₓ=AlphaLUT(k+1). Alphaₘᵢₙ is therefore the value of AlphaLUT at position k and Alphaₘₐₓ is therefore the value of AlphaLUT at position k+1. Thus, a simple 1D table can convey information which refers to a polynomial representing information such as % or color. In step 16, an interpolation is performed to obtain the value of Alpha(x,y), where Alpha(x,y) is a function of Alphaₘᵢₙ, Alphaₘₐₓ, v₀, u₀, Pₖ(u₀) and Pₖ₊₁(u₀). In step 17, the value of Alpha(x,y) is output.

The method illustrated in FIG. 3 can be implemented in devices such as microscopes, endoscopes, 3D video glasses, camera devices or the like. Numerous other devices are conceivable and possible.

A method that accelerates the interpolation and reduces the hardware requirements can be effected by dividing the segment with interpolation points. The example given in FIG. 3 is used as an illustration.

Assume that the data point (u₀,v₀) is between the curves representing, for example, a hemoglobin concentration and given by the polynomials P₃(u) and P₄(u), which represent a hemoglobin concentration of 30% and 40%.

In the case of a linear interpolation, the ratio β is determined, which is given by the following expression:

β=(v₀−P₄(u₀))/(P₃(u₀)−P₄(u₀))

The hemoglobin concentration τ (in %) of the data point (u₀,v₀) is now given by:

τ(u₀,v₀)=40%−β×10%

However, a division as defined in the formula for β is relatively complex in the hardware domain. Therefore, an approach using interpolation points is proposed. (n−1) interpolation points are inserted between the polynomial boundaries, where n is an integer. The approach with interpolation points is relatively simple to implement in the hardware domain. The following applies:

$$Interpolation - {point}_{0} = {P}_{4} ( {u}_{0} )$$

$$Interpolation - poin {t}_{1} = {P}_{4} ( {u}_{0} ) - 1 \times ( {P}_{3} ( {u}_{0} ) - {P}_{4} ( {u}_{0} ) ) / n$$

$$Interpolation - {point}_{2} = {P}_{4} ( {u}_{0} ) - 2 \times ( {P}_{3} ( {u}_{0} ) - {P}_{4} ( {u}_{0} ) ) / n$$

$$…$$

$$Interpolation - po i n {t}_{n} = {P}_{4} ( {u}_{0} ) - n \times ( {P}_{3} ( {u}_{0} ) - {P}_{4} ( {u}_{0} ) ) / n = {P}_{3} ( {u}_{0} )$$

The value of v₀ is then compared with the value of the interpolation point, wherein the value of the next interpolation point is selected. This is possible using a simple difference query, where Difference(k)=|v₀−interpolation-pointₖ| for k=0, 1, . . . , n. The value of the interpolation point that has the smallest absolute difference is then selected. The greater the number of interpolation points (n−1), the more accurate this method becomes. Other selection criteria than that of the “nearest neighbor” are also conceivable.

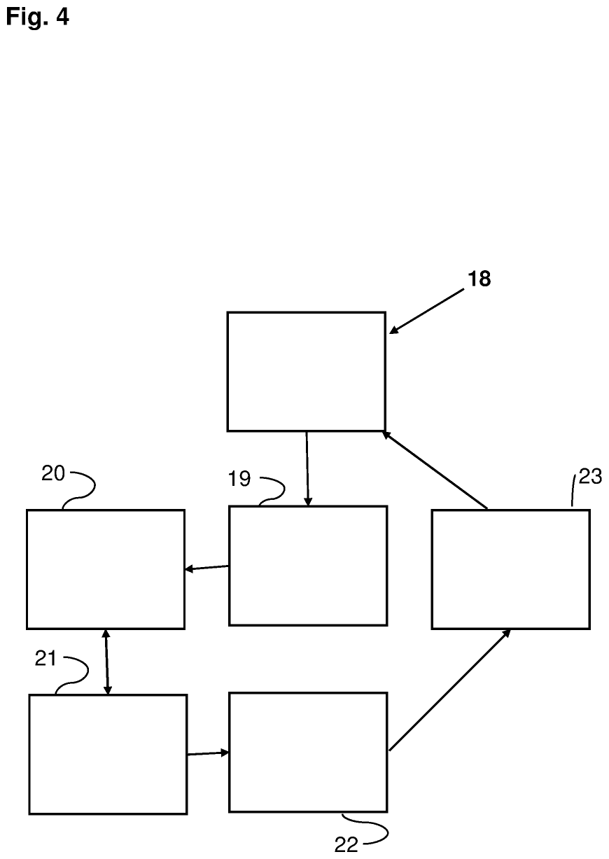

FIG. 4 shows a transformation device (18) having the features of the stand-alone claim. The data field (19) is imported. In addition, the data point to be transformed can be imported. A segmentation (20) is applied to the data field. This can be carried out using polynomials or other functions. A test (21) is performed to find the segment in which the data point to be transformed is located. Based on this test, a transformation rule (22) is selected and applied. An output (23) is provided. The output (23) is fed to the transformation device (18). The transformation device (18) can contain means which can carry out the procedures described above. Such means may be or comprise FPGAs, microchips or the like.

The invention relates to a method and a device for applying a transformation to a data field, wherein data points are transformed using at least one transformation rule, characterized in that the data field is divided into segments, that for each data point to be transformed of the data field a test is performed to identify the segment in which the data point is arranged, and that a transformation rule is subsequently selected depending on the segment found and the rule is applied to said data point.

### LIST OF REFERENCE SIGNS

1 Data import
2 Segmentation of the data field and testing the position of the data point
3 Calculation of segment boundary values of the segment boundaries
4 Interpolation
5 Data import
6 Segmentation of the data field and calculation of all radii
7 Testing the position of the data point
8 Calculation of segment boundary values of the segment boundaries
9 Interpolation
10 Parameter output
11 Data import
12 Color transformation
13 Data output
14 Segmentation of the data field and determination of the position of the data point
15 Calculation of the segment boundary values of the segment boundaries
16 Interpolation
17 Data output
18 Transformation device
19 Data field
20 Segmentation
21 Testing
22 Transformation rule
23 Output
24 Data point
25 Segment
26 Data field
27 Data field
28 Data point
29 Segment
30 Boundary
31 Data field
32 Data point
33 Segment

1. A method for applying a transformation to a data field, the method comprising:
transforming data points using at least one transformation rule, including
dividing the data field into segments,
for each data point to be transformed of the data field, performing a test to identify a segment in which the data point is arranged, and
subsequently selecting the transformation rule depending on the segment found and applying the transformation rule to said data point.

2. The method as claimed in claim 1, wherein the transformation rules are given by at least one function.

3. The method as claimed in claim 2, wherein the function is a polynomial.

4. The method as claimed in claim 1, wherein boundaries of the segments are described by at least one function.

5. The method as claimed in claim 4, wherein the at least one function are polynomials, with equipotential surfaces of the at least one function, there are multiple segments, and a respective one of the segments belonging to one of the data points is determined by finding the equipotential surfaces between which the data point is located.

6. The method as claimed in claim 4, wherein at least one transformation of the boundary of the segment enters into the transformation rule of the segment.

7. The method as claimed in claim 4, wherein, if the data point to be transformed is located between the boundaries of the segments, an interpolation is applied between segment boundary values of the boundaries of the segments.

8. The method as claimed in claim 1, wherein the data field is at least two-dimensional.

9. The method as claimed in claim 1, wherein the transformation changes a dimension of the data field.

10. The method as claimed in claim 1, wherein the transformation does not change a dimension of the data field.

11. The method as claimed in claim 1, wherein the transformation acts on dimensions of the data field that define a segmentation.

12. The method as claimed in claim 1, wherein the transformation acts on dimensions of the data field that do not define a segmentation.

13. The method as claimed in claim 7, further comprising carrying out the interpolation using a linear, bilinear, trilinear, bicubic, or polynomial or according to a nearest neighbor method.

14. The method as claimed in 13, wherein the interpolation comprises a subdivision of the segment into interpolation points and as a transformation value for the data point in the segment, a value is selected which corresponds to the transformation value of the nearest interpolation point.

15. The method as claimed in claim 1, wherein the method is used for at least one of geometric transformations, color transformations, or for generating additional parameters.

16. The method as claimed in claim 15, wherein the method is used for hemoglobin, hematocrit concentrations, or oxygen saturations.

17. A transformation device including: a processor configured for applying a transformation to a data field, wherein data points are transformable using at least one transformation rule, the processor is further configured to divide the data field into segments, to test each data point of the data field to be transformed, to determine a segment in which the data point is arranged, to select a transformation rule depending on the segment that is determined, and to apply the selected transformation rule for the transformation of the data point.
